(19) United States
(12) Patent Application Publication
(10) Pub. No.: US 2004/0047936 A1
(43) Pub. Date: Mar. 11, 2004

(54) Injection unit for a plastic injection molding machine

(76) Inventors: Gunther Fischbach, Furstenfeldbruck (DE); Ralf Meyer, Wetter (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/416,629

(22) PCT Filed: Nov. 12, 2001
(86) PCT No.: PCT/DE01/04262

(30) Foreign Application Priority Data
Nov. 16, 2000 (DE) 100 57 741.5

(51) Int. Cl. B29C 45/50

(52) U.S. Cl. 425/145; 425/166; 425/574

(57) ABSTRACT

The invention relates to an injection unit for an injection-molding machine, in particular for plastics, with a screw which is connected to a first actuator for rotating movement and to a second actuator for axial movement. In this case, the first actuator (21) is an electric motor, the second actuator (31) is a pressure bellows which can be filled with gas by a filling device (51), it being possible for the volume of the pressure bellows (31) to be altered by adjusting elements (32).

The invention relates to an injection unit for an injection-molding machine, in particular for plastics, with a screw which is connected to a first actuator for rotating movement and to a second actuator for axial movement.

EP 0 280 743 B1 discloses an injection-molding machine in which the screw can be rotated by a first actuator and can be moved linearly in relation to the rotary drive by a second actuator. Both actuators are electrically driven, a gaseous medium is not used.

WO 94/09982 discloses a pressure controlling and/or regulating device in which a fluidic medium is fed to the polymer melt in an injection mold, these medium inflow control valves being actuable by the valve control in dependence on the pressure difference respectively present at a pressure sensor.

This pressure generator/accumulator is intended only for an injection system, not for axial displacement of the screw of an injection-molding machine.

The object of the invention is to provide an injection unit of a simple construction which permits reliable axial adjustment of the screw with low energy consumption.

The invention achieves this object by the features of claim 1. The remaining claims are advantageous developments of the invention. According to the invention, the injection unit of the injection-molding machine concerned here, in particular for plastics, has a first actuator, which is designed as an electric motor, and a second actuator, which is designed as a pressure bellows and the volume of which can be altered by adjusting elements.

The housing of the pressure bellows may in this case be constructed from rubber or from metal. The pressure bellows can be compressed by a fixed plate and a movable plate by means of adjusting elements. In one embodiment, the adjusting elements are formed as springs, which counteract the internal pressure of the pressure bellows. The springs may in this case be provided independently of the housing of the pressure bellows, but they may also be configured as a metallic compensator which at the same time forms the housing of the pressure bellows.

In one particular embodiment, the adjusting elements are spindle nut units, in which at least one component is driven. It is particularly advantageous for the spindle to be designed as a ballscrew which is driven and moves in a fixed nut.

To prescribe the exact rotational movement, the rotational speed is sensed and brakes, preferably disk brakes, are provided on the spindles, permitting low-maintenance braking.

In a further embodiment of the injection unit, the pressure bellows is provided with a counter-bellows, the two bellows being connected to each other by means of an adjusting valve connected in the conveying direction.

It is additionally proposed to design the electric motor as a hollow-shaft motor, in particular as a reluctance motor.

In a further advantageous embodiment, the pressure bellows is of an annular design, and if appropriate the counter-bellows is likewise of an annular design, the connecting shaft being such that it can pass centrally through the pressure bellows, so that the rotating motor can be arranged on the side of the pressure bellows remote from the screw.

For the exact guidance of the linear movement, it is further proposed to provide a pressure gage, which is connected to a measuring and regulating device by which the axial expansion of the pressure bellows can be controlled.

An example of the invention is represented in the accompanying drawing, in which:

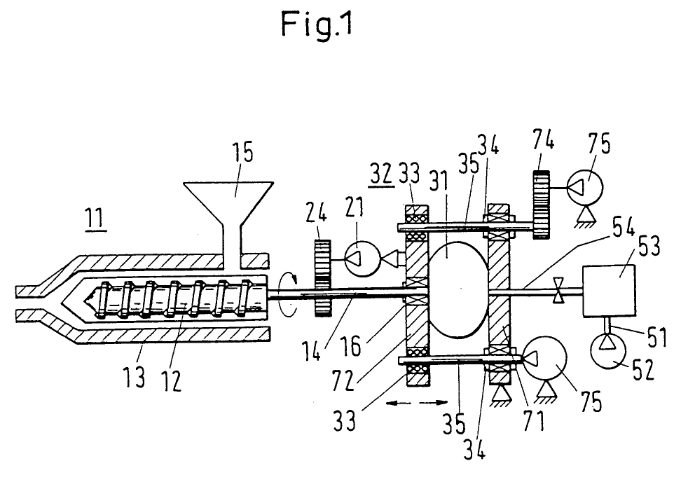

FIG. 1 shows an injection unit with the arrangement of the rotating motor between the pressure bellows and the screw

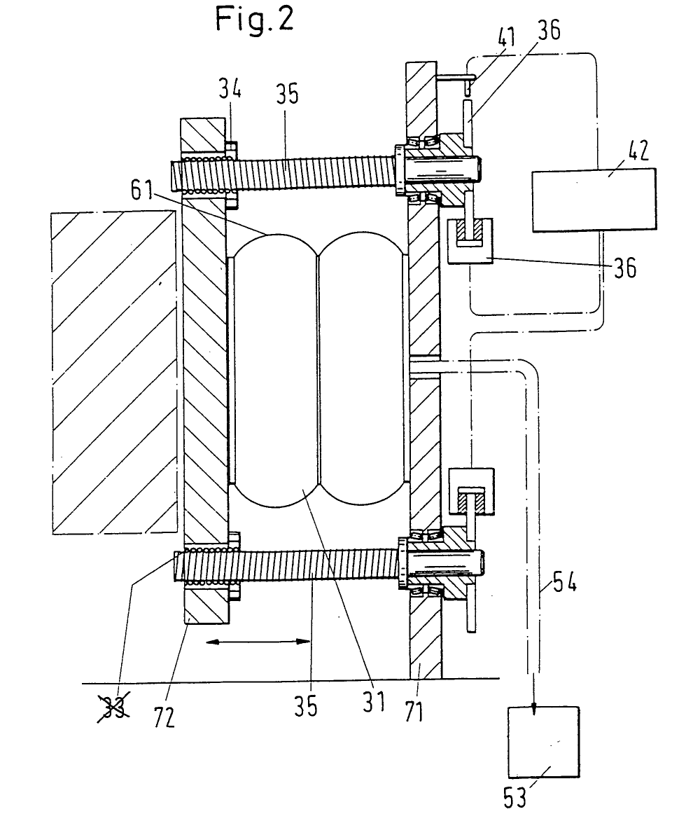

FIG. 2 shows a ballscrew with disk brake

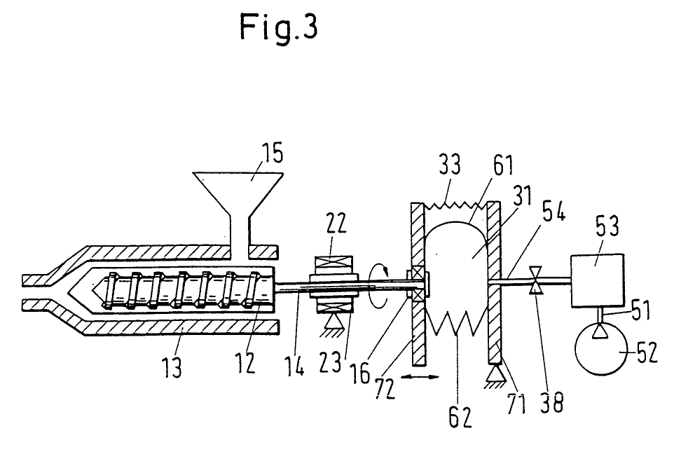

FIG. 3 shows a hollow-shaft motor as a rotating motor and springs for the adjustment of the bellows

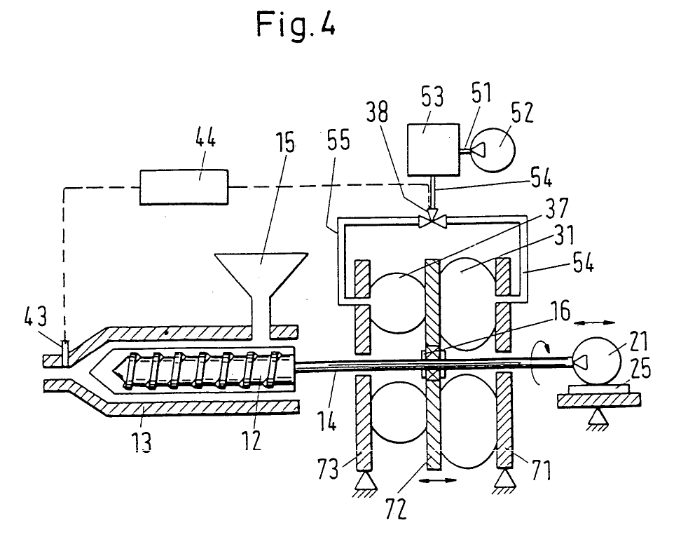

FIG. 4 shows an injection unit with a connecting shaft passed through the annular bellows.

In this case, FIG. 1, FIG. 3 and FIG. 4 show an injection-molding machine 11 with a screw 12 arranged in a cylinder 13. The screw is connected to a connecting shaft 14. Provided on the cylinder 13 is a filling hopper 15.

Furthermore, a pressure bellows 31 is arranged between a fixed pressure plate 71 and a movable pressure plate 72. The pressure bellows 31 is connected via a pressure line 54 to a pressure accumulator 53, which is in connection with a pump 52 via a guiding device 51. Arranged on the pressure line 54 is an adjusting valve 38.

In FIG. 1, the first actuator is an electric motor 21, which is in connection with the connecting shaft 14 via a gear mechanism 24. In the present example, the electric motor 21 is supported on the movable pressure plate 72.

A nut/spindle unit 34, 35, which is connected—in the upper part of the figure via a gear mechanism 74—to a motor 75, is provided as adjusting elements for the pressure plate 73, 72.

The connecting shaft 14 is rotationally mounted in a connecting bearing 16 connected to the movable pressure plate.

In FIG. 2, the nut 34 is arranged in the movable pressure plate 72. The nut 34 is in operative connection with a ballscrew 35, which is mounted in the fixed platen and, arranged on the ballscrew 35, on the side of the fixed pressure plate 71 facing away from the bellows 31, is a disk brake 36. The disk brake 36 is in metrological connection with a speed sensing means 41, which is connected to a measuring and regulating device 42.

The pressure bellows 61, constructed here as rubber, is connected to the pressure accumulator 53 via the pressure line 54.

In FIG. 3, the connecting shaft 14 is driven by a hollow-shaft motor 22, which is designed as a reluctance motor 23.

The connecting shaft 14 is mounted in a connecting bearing 16 connected to the movable pressure plate 72.

Provided as the adjusting element of the pressure bellows 31, in the upper part of the figure, is a spring 33, which is in operative connection with the pressure plates 71 and 72.

In the lower part of the figure, the pressure bellows is designed as a metallic compensator 62, the compensator being operatively connected as a spring to the pressure plates 71 and 72.

In FIG. 4, the connecting shaft 14 is guided up to the side of the fixed pressure bellows 71 remote from the screw 12. The connecting shaft 14 is rotated by an electric motor 21, which is axially movable on a rail.

A counter-bellows 37, which at one end leans against the movable pressure plate, on which the pressure bellows 31 is also supported, and at the other end connected to a second fixed pressure plate 73 is provided as an adjusting element.

The pressure bellows 31 and the counter-bellows 37 are connected to the pressure actuator 53 via pressure line 54 or 55, via an adjusting valve 38.

Also arranged on the screw/cylinder unit 12, 13 is a pressure gage, which is connected to a measuring and regulating device 44, which is connected in control terms to the adjusting valve 38.

List of items

| Injection | |
|---|---|
| 11 | Injection-molding machine |
| 12 | Screw |
| 13 | Cylinder |
| 14 | Connecting shaft |
| 15 | Filling hopper |
| 16 | Connecting bearing |
| Rotation | |
| 21 | First actuator, electric motor |
| 32 | Hollow-shaft motor |
| 23 | Reluctance motor |
| 34 | Gear mechanism |
| 35 | Rail |
| Axial movement | |
| 31 | Second actuator, pressure bellows |
| 32 | Adjusting element |
| 33 | Spring |
| 34 | Nut |
| 35 | Spindle |
| 36 | Brake |
| 37 | Counter-bellows |
| 38 | Adjusting valve |
| Measuring | |
| 41 | Speed sensing means |
| 42 | Measuring and regulating device, brake |
| 43 | Pressure gage |
| 44 | Measuring and regulating device, bellows |
| Filling | |
| 51 | Filling device |
| 52 | Pump |
| 53 | Pressure accumulator |
| 54 | Pressure line (31) |
| 55 | Pressure line (37) |
| Material | |
| 61 | Rubber |
| 62 | Metal compensator |
| Plates | |
| 71 | Fixed pressure plate |
| 72 | Movable pressure plate |
| 73 | Second fixed pressure plate |
| 74 | Gear mechanism |
| 75 | Drive |

1. An injection unit for an injection-molding machine, in particular for plastics, with a screw which is connected to a first actuator for rotating movement and to a second actuator for axial movement, characterized in that the first actuator (21) is an electric motor, in that the second actuator (31) is a pressure bellows which can be filled with gas by a filling device (51) and in that the volume of the pressure bellows (31) can be altered by adjusting elements (32).

2. The injection unit as claimed in claim 1, characterized in that the adjusting elements (32) are formed as a spring (33) which counteract the internal pressure of the pressure bellows (31).

3. The injection unit as claimed in claim 2, characterized in that the adjusting elements (32) are spindle/nut units (34, 35).

4. The injection unit as claimed in claim 3, characterized in that the adjusting elements (32) are drivable ballscrews (35), which are in operative connection with nuts (34).

5. The injection unit as claimed in claim 4, characterized in that each ballscrew (35) is provided with a brake (36), preferably a disk brake.

6. The injection unit as claimed in claim 4 or 5, characterized in that on the ballscrew (35) there is provided a speed sensing means (41), which is connected to a measuring and regulating device (42) by which the spindle rotation can be prescribed in direction and speed.

7. The injection unit as claimed in claim 1, characterized in that a counter-bellows (37), which is connected to the pressure bellows (31) via an adjusting valve (38), is provided as an adjusting element (32).

8. The injection unit as claimed in claim 7, characterized in that the adjusting valve (38) is connected to the conveying device (53).

9. The injection unit as claimed in claim 1, characterized in that the electric motor (21) is designed as a hollow-shaft motor (22).

10. The injection unit as claimed in claim 9, characterized in that the electric hollow-shaft motor (22) is a reluctance motor.

11. The injection unit as claimed in one of the aforementioned claims, characterized in that at least the pressure bellows (31) is of an annular form and in that the connecting shaft (14) is guided between the electric motor (21), provided for the rotating movement of the screw (12), from the screw (12) up to the side of the pressure bellows (31) remote from the screw (12).

12. The injection unit as claimed in one of the aforementioned claims, characterized in that pressure gages (43) which are connected to the screw-cylinder unit (12, 13) and to a measuring and regulating device (44), by which the axial expansion of the pressure bellows (31) can be controlled, are provided.

13. The injection unit as claimed in claim 1, characterized in that the material of the housing of the pressure bellows (31) is rubber (61).

14. The injection unit as claimed in claim 1, characterized in that the housing of the pressure bellows (31) is made of metal (62), which has the form of a compensator.
